(19) United States
(12) Patent Application Publication
(10) Pub. No.: US 2008/0192889 A1
(43) Pub. Date: Aug. 14, 2008

(54) HANDHELD X-RAY FLUORESCENCE SPECTROMETER

(76) Inventors: Martin Rohde, Berlin (DE); Larry Stephen Price, Richland, WA (US); Vassili Kobyitchak, Richland, WA (US)

Correspondence Address: Patent Docket Department;Armstrong Teasdale LLP, One Metropolitan Square, Suite 2600, St. Louis, MO, 63102-2740, US

(21) Appl. No.: 12/031,077

(22) Filed: Feb. 14, 2008

Related U.S. Application Data
(60) Provisional application No. 60/889,890, filed on Feb. 14, 2007.

(51) Int. Cl. G01N 23/223

(52) U.S. Cl. 378/45

(57) ABSTRACT

A handheld X-ray fluorescence (XRF) spectrometer is described. The handheld XRF spectrometer comprises a radiation source, a silicon drift detector (SDD), a cooling device configured to regulate the temperature of the SDD, at least one signal processing and power control module coupled to at least one of the radiation source, the SDD, and the cooling device, and a housing substantially encasing the radiation source, the SDD, the cooling device, and the at least one signal processing and power control module. The at least one signal processing and power control module includes at least one input/output connector.

### CROSS REFERENCE TO RELATED APPLICATIONS

This application claims the benefit of U.S. Provisional Patent Application No. 60/889,890, filed Feb. 14, 2007, which is hereby incorporated by reference in its entirety.

### BACKGROUND OF THE INVENTION

This invention relates generally to X-ray fluorescence (XRF) and more specifically to performing elemental analysis using a handheld XRF spectrometer.

XRF is the emission of characteristic (also referred to as secondary or fluorescent) X-rays from a material that has been excited by, for example, high-energy X-rays, gamma rays, an electron beam, or a radioactive source directed at the material. One specific use of XRF is chemical analysis of a liquid or a solid sample.

An XRF spectrometer is used to examine the composition of the sample. X-rays are usually irradiated onto a surface of the sample, and the X-ray fluorescence radiation emitted by the sample is detected, the wavelength distribution of the emitted radiation being characteristic of the elements present in the sample, while the intensity distribution gives information about the relative abundance of the sample components. By means of a spectrum obtained in this manner, an expert typically is able to determine the components and quantitative proportions of the examined test sample.

It is common for known XRF spectrometers to include a sample chamber. During a measurement, the sample is held in a fixed measuring position in the sample chamber. The sample chamber is either evacuated during the measurement or is flooded with an inert gas, such as helium. Performing the measurement under high vacuum prevents air from attenuating the secondary radiation. In order to establish measuring conditions, the sample chamber is connected to a pumping system since, during introduction of a new test sample into the sample chamber, air from the surrounding atmosphere enters the sample chamber and such air is removed from the chamber prior to the actual measurement. Furthermore, known XRF spectrometers also may include a transfer chamber. The transfer chamber is used to facilitate introducing the test sample to the sample chamber.

With known handheld XRF spectrometers, a sample is placed against the handheld XRF spectrometer that includes a detector. Known handheld XRF spectrometers include traditional detectors such as, for example, Silicon Pin, Cadmium Telluride, Cadmium Zinc Telluride, and Mercuric Iodide detectors. Although portable, handheld XRF spectrometers that include these types of detectors typically are limited by resolution and fluorescence efficiency of the elements being analyzed. Specifically, current handheld XRF spectrometers typically lack the ability to analyze elements with certain Atomic Numbers.

A tradeoff for portability and ease of use therefore is that such portable spectrometers have a limited range of element analysis as compared to the typical non-portable spectrometer.

### BRIEF DESCRIPTION OF THE INVENTION

In one embodiment, a handheld X-ray fluorescence (XRF) spectrometer is described. The handheld XRF spectrometer comprises a radiation source, a silicon drift detector (SDD), a cooling device configured to regulate the temperature of the SDD, at least one signal processing and power control module coupled to at least one of the radiation source, the SDD, and the cooling device, and a housing substantially encasing the radiation source, the SDD, the cooling device, and the at least one signal processing and power control module. The at least one signal processing and power control module includes at least one input/output connector.

In another embodiment, a signal processing and power control module for use with an X-ray fluorescence (XRF) spectrometer that includes a silicon drift detector (SDD) is provided. The module includes at least one system controller configured to provide power and control instructions to at least one of a radiation source and a cooling device. The module also includes at least one signal processor configured to receive operating information from at least one of the radiation source and the cooling device, the at least one signal processor further configured to provide the operating information to a computing device.

In yet another embodiment, a method of controlling operation of a handheld X-ray fluorescence (XRF) spectrometer that includes a silicon drift detector (SDD) is provided. The method includes configuring a signal processing and power control module to distribute electrical power from a power source to a plurality of components of the XRF spectrometer. The components of the XRF spectrometer are selected to operate within a predetermined voltage range. The method also includes configuring the signal processing and power control module to control operation of at least one of a radiation source and a cooling device.

### BRIEF DESCRIPTION OF THE DRAWINGS

FIG. 1 is a functional illustration of a detection apparatus.

FIG. 2 is a perspective view of an exemplary embodiment of a handheld XRF spectrometer.

FIG. 3 is a schematic diagram of a known handheld XRF spectrometer.

FIG. 4 is a schematic diagram of a handheld XRF spectrometer including a silicon drift detector.

FIG. 5 is an enlarged schematic diagram of a nosepiece of a handheld XRF spectrometer including a silicon drift detector.

FIG. 6 is a block diagram of an XRF spectrometer 80.

FIG. 7 is a diagram illustrating power outputs of a signal processing and power control module.

FIG. 8 is a schematic diagram of a handheld XRF spectrometer including a silicon drift detector, the handheld XRF spectrometer in communication with a processing device.

FIG. 9 is a cross-sectional perspective view of a nosepiece of a handheld XRF spectrometer including a silicon drift detector.

### DETAILED DESCRIPTION OF THE INVENTION

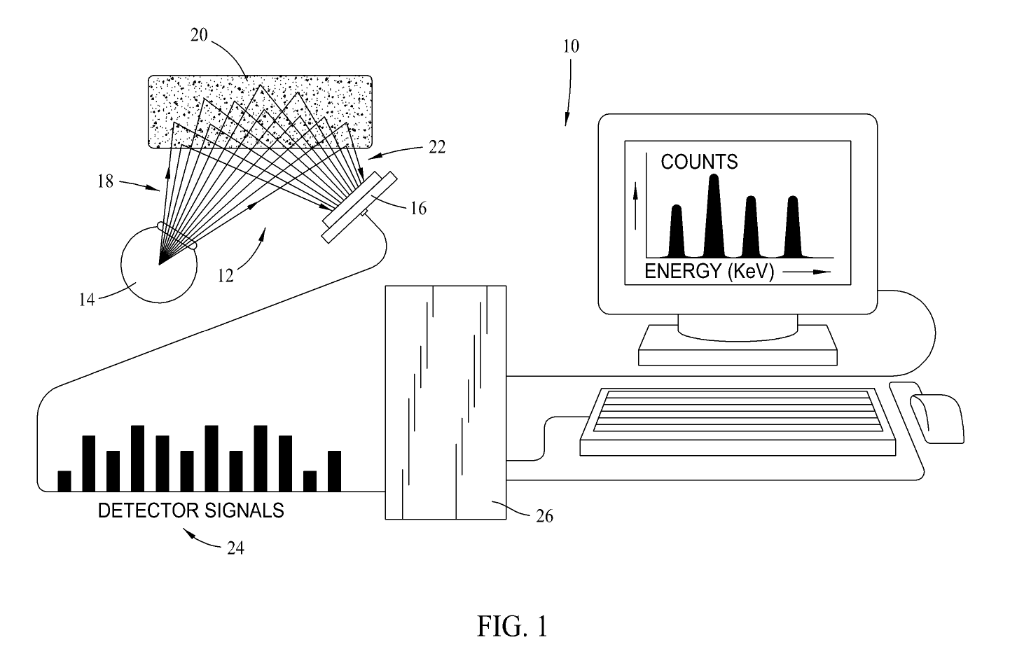

FIG. 1 is a functional illustration of the general components of a detection apparatus 10. In the illustrated embodiment, detection apparatus 10 is an X-ray fluorescence (XRF) spectrometer 12. XRF spectrometer 12 includes a primary beam source 14, and a detector 16. In the illustrated embodiment, primary beam source 14 is an X-ray tube that projects a primary beam of X-rays 18 towards a sample 20 that is to be tested. In another exemplary embodiment, primary beam source 14 is a radioactive isotope, which projects a primary beam of gamma rays towards the sample 20. In yet another exemplary embodiment, primary beam source 14 is an electron beam source that projects a primary beam of electrons towards the sample 20. Any suitable beam source, or plurality of sources, known in the art can be used as primary beam source 14.

Sample 20 becomes excited after being exposed to primary beam 18. This excitation causes sample 20 to emit a secondary (i.e. characteristic or fluorescent) radiation 22. Secondary radiation 22 is collected by detector 16. Detector 16 includes electronic circuitry, which is sometimes referred to as a preamplifier, that converts collected secondary radiation to a detector signal 24 (i.e., a voltage signal or an electronic signal) and provides the detector signal 24 to an analyzer 26. In one embodiment, analyzer 26 includes a digital pulse processor. While illustrated as a non-handheld unit, detection apparatus 10 illustrates the major components that are also utilized in a handheld spectrometer.

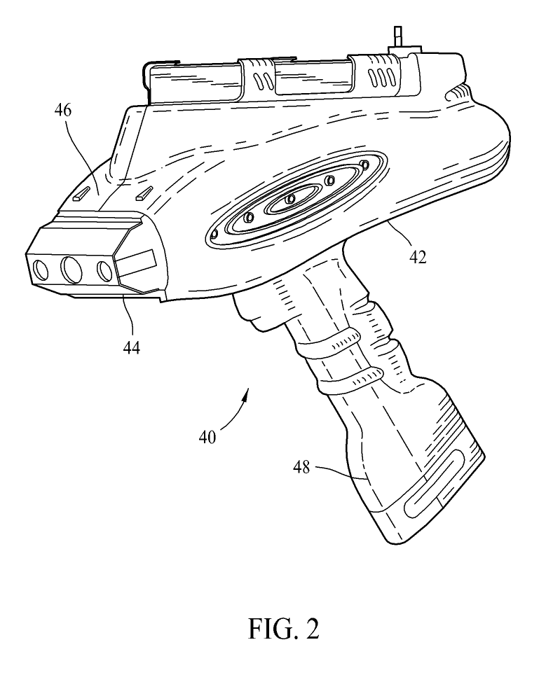

FIG. 2 is perspective view of an exemplary embodiment of a handheld XRF spectrometer 40. Handheld XRF spectrometer 40 includes a housing 42. Housing 42 encloses and protects the internal assemblies of handheld XRF spectrometer 40.

Housing 42 of handheld XRF spectrometer 40 includes a nosepiece 44 and a body 46. In an exemplary embodiment, housing 42 may have a “handgun-shaped” profile, with a handle 48, extending from body 46. Handle 48 may be positioned such that the user may comfortably hold handle 48 and direct nosepiece 44 to a desired position. Handheld XRF spectrometer 40 includes components similar to those described with respect to FIG. 1, including a detector, a beam source, and an analyzer.

In an exemplary embodiment, housing 42 may be composed of one, or a combination of the following: ABS plastics, and alloy materials such as Magnesium, Titanium, and Aluminum. Housing 42 may be composed of any material with the strength to encase and protect the internal components of handheld XRF spectrometer 40. This protection may include, but is not limited to, protection from elements such as wind and rain, protection from dust and other impurities, and protection from damage caused by dropping spectrometer 40 onto a surface or from rough handling of spectrometer 40. This protection may also be bolstered through the use of over molding, rubber bumpers, shock absorbing mounts internal to the instrument assembly, and/or the use of crushable impact guards.

In one embodiment, housing 42 is composed of lightweight materials, as when in use, handheld XRF spectrometer 40 is held by one of a user's hands. A light weight handheld XRF spectrometer 40 increases maneuverability and increases the ease-of-use of handheld XRF spectrometer 40 over a heaver handheld spectrometer.

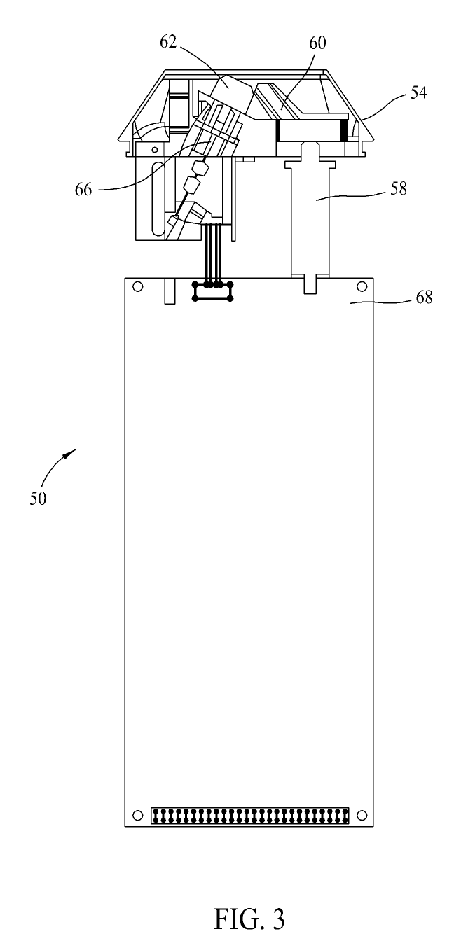

FIG. 3 is a schematic diagram of a known handheld XRF spectrometer 50. An X-ray tube 58 is positioned within a nosepiece 54. X-ray tube 58 directs primary X-rays through a collimator 60. Collimator 60 is configured to allow X-rays traveling parallel to a specified direction to pass through. A detector 62 is also positioned within nosepiece 54. In known handheld XRF spectrometers, detector 62 includes one of a silicon pin detector, a cadmium telluride detector, and a mercuric iodide detector. Nosepiece 54 also includes a preamplifier 66. Preamplifier 66 amplifies voltage signals produced by detector 62 that correspond to the secondary radiation received by detector 62. Preamplifier 66 also provides the voltage signals to a digital pulse processor 68 for final processing.

Detector 62 typically includes a cylindrical wafer of semiconductor material with rectifying p or n contacts on a top and a bottom of the detector forming a diode. The diode is cooled on its bottom side by, for example, a single or double stage Peltier cooler. Detector 62 has a bias voltage across it to move the electrons generated by the colliding photons from the sample to a collection point. The typically negative bias voltage on the front of the detector attracts the holes generated in the semiconductor and repels the electrons. A negative charge cloud is generated that drifts to the rear contact and is converted by, for example, a Field Effect Transistor (FET) to a voltage signal with a shape corresponding to the detected secondary radiation.

The number of electrons produced in the negative charge cloud is directly proportional to the energy of the secondary radiation collected by the detector. The amount of charge collected creates a voltage pulse of a magnitude that is directly proportional to the energy of the detected secondary radiation. The diode, Peltier cooler, and FET are located in a high vacuum metal enclosure, for example a Nickel enclosure, which includes a window that enables the secondary radiation to reach the front of the diode. The diode leads to electrical connectors that pass through the bottom of the detector enclosure and attach bias voltage, supply Peltier cooler power, and lead to a preamplifier.

The level of capacitance between the detector anode to ground demands signal noise filtering with high time constants (i.e., 10-20 uSec). The high time constants unfavorably limit the detector throughput to counts per second in the range of tens of thousands counts per second. However, the high time constants allow for the use of low bandwidth electronics (i.e., 1 MHz), which is beneficial because typically low bandwidth electronics consume less power and more easily handle noise than higher bandwidth electronics. In addition, in typical XRF spectrometers 50, individual components utilize different operating voltage levels. Multiple power sources may provide these various voltage levels and/or conditioning circuits may change the power levels within the spectrometer 50.

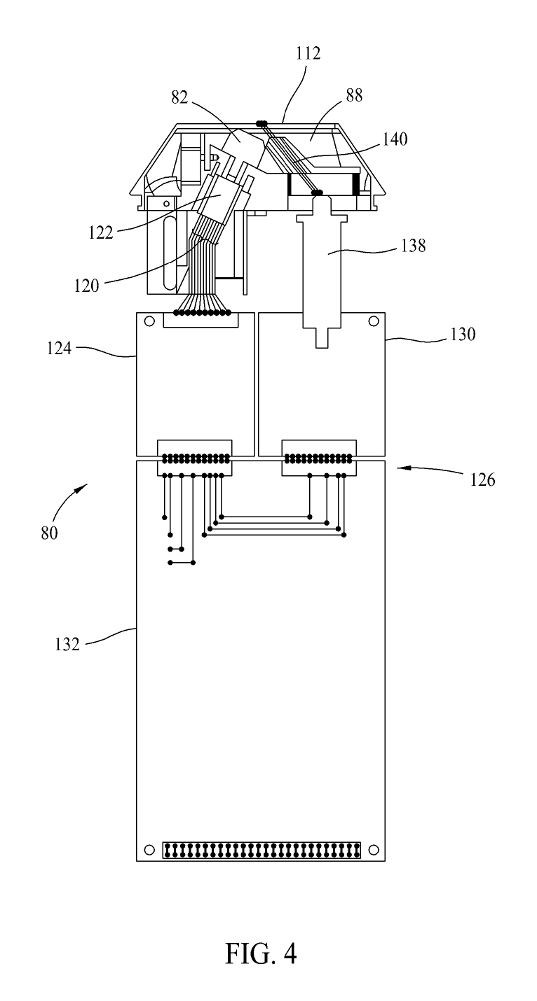

FIGS. 4-8 are various illustrations of a handheld XRF spectrometer 80 that includes a silicon drift detector (SDD) 82. More specifically, FIG. 4 is a schematic diagram of handheld XRF spectrometer 80 that includes SDD 82. Handheld XRF spectrometer 80 is encased in a housing, similar to housing 42 described above, and includes a nosepiece 88 and a body (not shown in FIG. 4). In an exemplary embodiment, the housing has the same profile as housing 42 (shown in FIG. 2). In an exemplary embodiment, housing 42 has overall dimensions of less than thirty cubic centimeters and a weight of less than or equal to two kilograms.

SDD 82 is contained in a protective enclosure, for example, an enclosure composed of nickel or stainless steel. The protective enclosure also includes a thin window 112. In an exemplary embodiment, thin window 112 is composed of Beryllium. Thin window 112 allows for electronic shielding and ambient light shielding while allowing secondary radiation to pass through. The protective enclosure also includes at least one sealed electrical contact 120 that extends through the walls of the enclosure. The at least one electrical contact 120 provides a connection between a plurality of preamplifiers including, in one embodiment, a preamplifier 122 and a preamplifier 124. The at least one electrical contact 120 also provide at least one biasing voltage to SDD 82. As described above, a secondary radiation may be attenuated by air, therefore a vacuum or an area flooded with inert gas is maintained by the protective enclosure to prevent this attenuation.

Handheld XRF spectrometer 80 includes a signal processing controller 126 that receives and processes an electrical signal from SDD 82 that corresponds to detected secondary radiation. In an exemplary embodiment, controller 126 includes preamplifier 124, at least a third pre-amplification stage 130, and a digital pulse processor 132. Preamplifiers 124 and 130 provide an interface for signals propagating between SDD 82 and digital pulse processor 132. In XRF spectrometer 80, signal processing controller 126 also provides functions relating to system control, cooler control, and power distribution and is further described as a signal processing and power control module below. To provide a handheld XRF spectrometer that incorporates a silicon drift detector, one or more circuits that support and provide an interface to SDD 82 are incorporated into handheld spectrometer 80. It should be recognized that handheld XRF spectrometer 80 includes additional preamplifier circuits 124 and 130, which are provided to support operation of SDD 82 and the interface between SDD 82 and digital pulse processor 132.

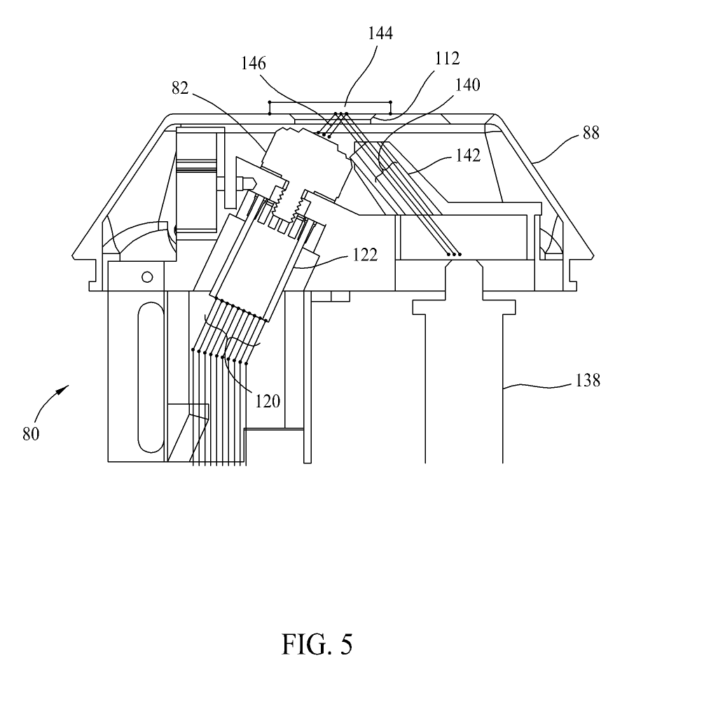

FIG. 5 is an enlarged schematic diagram of nosepiece 88 of handheld XRF spectrometer 80 of FIG. 4. Handheld XRF spectrometer 80 includes a radiation source 138. Radiation source 138 may include, but is not limited to, an electron beam source, a radioisotope source, a pyroelectric source, and an X-ray tube. In the illustrated embodiment of FIG. 5, radiation source 138 is an X-ray tube. X-ray tube 138 directs a primary X-ray beam 140 toward a primary beam collimator 142. A primary beam collimator 142 allows X-rays oriented in a particular manner to pass through and irradiate a sample 144, which is in a position to be tested.

After sample 144 is exposed to primary X-ray beam 140, the material of sample 144 is excited and secondary X-rays 146 are emitted by sample 144. Secondary X-rays 146 are detected by SDD 82. A suitable SDD 82 is commercially available from KETEK GmbH, of Munich, Germany. SDD 82 may be purchased, for example, in a standard TO8 transistor housing.

SDD 82 is typically fabricated using high-purity n-type silicon by providing at the entering photon side a large area pn-junction and the opposite side a central spot n-doped anode that is surrounded by a number of concentric p-type drift rings. During operation of SDD 82, the pn-junctions on both sides of the silicon are biased in reverse, generating a minimum of free electrons in the bulk.

By generating a voltage gradient across the drift rings, a traversal electric field is generated which bends the potential across each ring and forces the electrons to drift to the anode. The small capacitance of the anode together with the low leakage current of the silicon enable low noise and fast readings of the electron signal generated from the photon interaction with the detector surface. Each ring has a separate bias voltage and dedicated electronics for handling those voltages.

The low anode capacitance demands a time constant for optimal signal filtering to be of an order of magnitude less than those usual for Silicon PIN type detectors. The low time constant allows for a high throughput (e.g. hundreds of thousands and approaching millions of counts per second). Utilization of SDD 82 and signal processing techniques as further described below, allow for analysis times of ten seconds or less, and in certain analysis scenarios, analysis times less than one second. The low time constant also allows for a high signal to noise ratio, which results in an SDD having a high resolution. The high signal to noise ratio also allows the SDD to work at high temperatures. However, in an exemplary embodiment, the bandwidth of the signal processing electronics is increased in order to process the high throughput from the SDD. Compensation for noise in a higher bandwidth electronic circuit typically requires electronics that consume a greater amount of power than in a lower bandwidth electronic circuit.

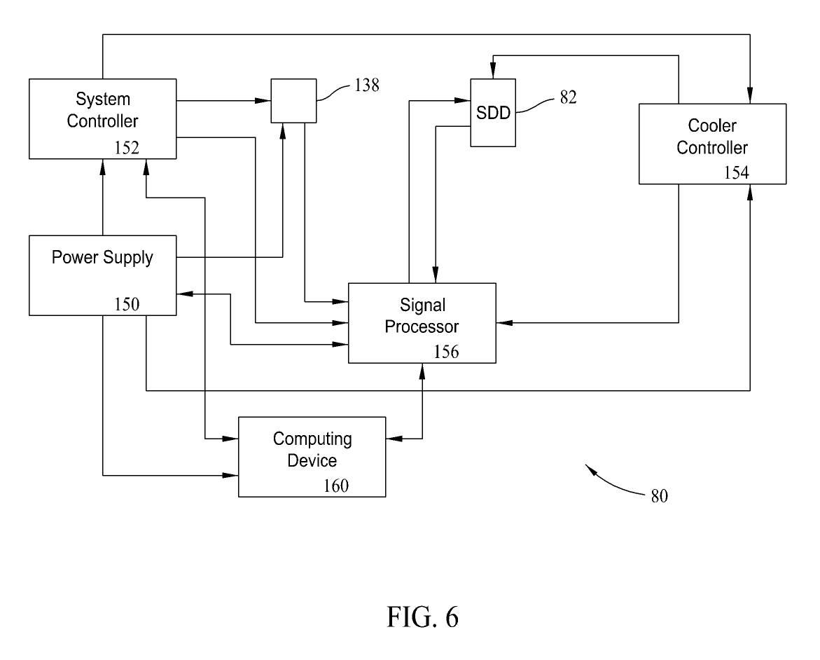

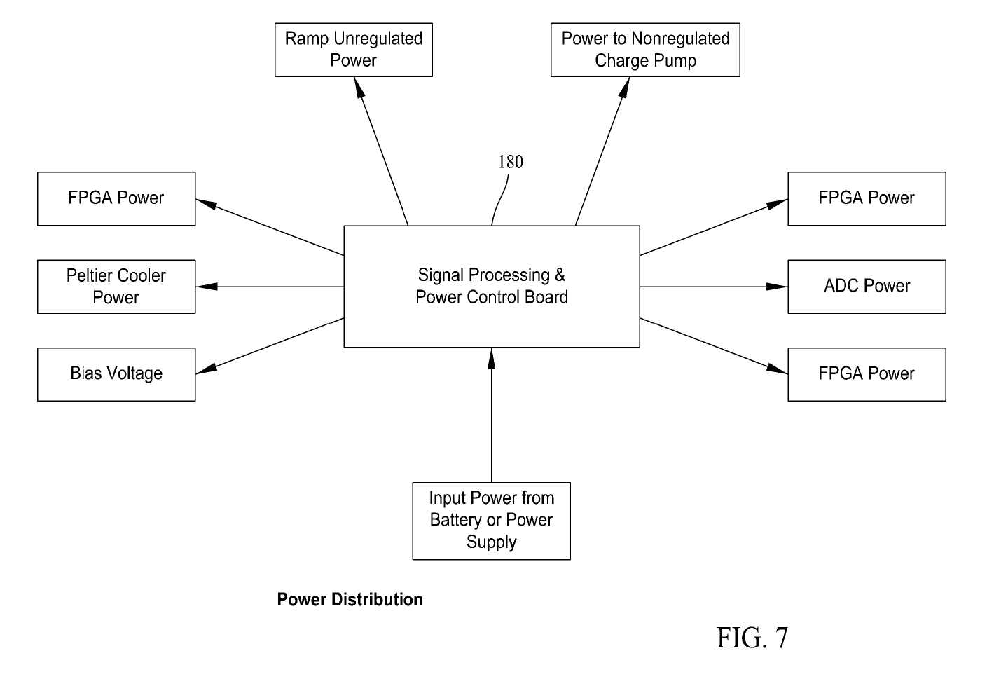

FIG. 6 is a functional block diagram of XRF spectrometer 80, described above. Power is supplied to XRF spectrometer 80 by a power supply 150. In an exemplary embodiment, power supply 150 is a battery or multiple batteries combined to produce a voltage and current. The battery provides appropriate voltages and currents to a power distribution network, while adding to the maneuverability of XRF spectrometer 80 by eliminating electrical power cords. Spectrometer 80 includes functions relating to system control 152, cooler control 154, and signal processing 156. A computing device 160 is also included in a specific embodiment. In one embodiment of XRF spectrometer 80, these functions are combined on a single signal processing and power control module (shown in FIG. 7).

Radiation source 138, in one example an X-ray source, receives power and control instructions from system controller 152. X-ray source 138 reports information on the operation of X-ray source 138 to signal processor 156. Signal processor 156 receives operating information from a cooler controller 154 and provides operating information from X-ray source 138 and cooler controller 154 to a computing device 160. Cooler controller 154 provides regulated temperature control to SDD 82. In one embodiment, cooler controller 154 controls a Peltier cooler that is positioned to lower the temperature at SDD 82.

In operation, SDD 82 receives secondary radiation emanated from a sample, converts the received radiation into an electrical signal, and provides the electrical signal to signal processor 156. Signal processor 156 routes the electrical signal to computing device 160 for processing and display.

In an exemplary embodiment, system controller 152 supplies SDD 82 with a plurality of separate bias voltages, as described above. Also, signal processor 156 is configured to analyze a plurality of electrical signals output by SDD 82.

In an embodiment described above, power supply 150 is a battery. In this embodiment, low power consumption by XRF spectrometer 80 increases the time XRF spectrometer 80 can operate before the battery looses its charge. The battery must either be replaced or recharged when the battery can no longer supply the voltages and currents necessary for operation of XRF spectrometer 80.

In an exemplary embodiment, illustrated in FIG. 7, XRF spectrometer 80 includes a signal processing and power control module 180 which, in part, provides power to the internal components of XRF spectrometer 80. In an exemplary embodiment, signal processing and power control module 180 includes at least one rigid circuit board that interconnects components of the module 180. However, in alternative embodiments, module 180 may include at least one flexible circuit board or any other component interconnections that facilitate operation of module 180 as described herein. Outputs of the power control portion of module 180 are sometimes referred to as a supply rail. Examples of power outputs from module 180 are shown in FIG. 7 and include one or more of bias voltages, a cooler power supply voltage, various field programmable gate array (FPGA) power voltages, ramp power, charge pump power, and analog-to-digital converter power. Internal components utilized on module 180 are selected to operate within a common voltage range, which reduces the number of buffers and signal conditioning components included in XRF spectrometer 80. By eliminating or reducing the number of power conversions necessary to in providing the functions of signal processing and power control module 180, a source of power loss is reduced, and the physical size of the power supply circuits are thus reduced.

In an embodiment, suspended operation, standby, and power-down modes are incorporated into module 180 to reduce the amount of power that is drawn from the battery. Suspended operation, standby, and power-down modes either reduce the amount of power provided to a particular component of XRF spectrometer 80 or discontinue providing power to a particular component of XRF spectrometer 80 for a period of time. For example, power may be suspended to X-ray source 138 between sample assessments. After power is re-applied to X-ray source 138, stability is not reached until a time period has passed. However, that time period may be used to lower the temperature of SDD 82 after the temperature of SDD 82 was allowed to rise to a power saving standby temperature by discontinuing or reducing power to cooler controller 154 when SDD 82 was not in use.

In another exemplary embodiment, suspended operation may include providing components of XRF spectrometer 80, including in one example, components of module 180, with a reduced amount of power with which to operate. The reduced amount of power may reduce the performance of these components by reducing clock frequency and/or disabling performance enhancing parts. However, even in this low-power mode, power is kept at a level where XRF spectrometer 80 is functional. By operating XRF spectrometer 80 in a low-power mode when maximum clock speeds are not necessary, battery power is conserved.

Due to the limited amount of power supplied by a battery sized with portability in mind, the output of X-ray source 138 does not reach the maximum pulse processing capacity of SDD 82. This mismatch between the pulse processing power of SDD 82 and the available X-ray power may be used to reduce power consumption. In another exemplary embodiment, XRF spectrometer 80 is operated in a pulsed mode. In the pulsed mode, XRF spectrometer 80, and in particular signal processing and power control module 180, includes at least one power storage capacitor. While the power storage capacitor is being charged, analysis of a sample does not occur. Instead, analysis of a sample occurs while X-ray source 138, SDD 82, and controller 126 are provided with short pulses of power from the power storage capacitor. The short pulses of X-rays are processed at the full native speed of SDD 82.

In yet another exemplary embodiment, power consumption of XRF spectrometer 80 may be reduced by operating in an intermediate mode. In the intermediate mode, as in the pulsed mode, analysis of a sample does not occur while the power storage capacitor is being charged. However, in the intermediate mode, secondary radiation is collected by SDD 82, which is powered by the battery, while X-ray source 138 is powered by the power storage capacitor.

In yet another exemplary embodiment, power consumption of XRF spectrometer 80 may be reduced by limiting the power consumed by module 180. In this embodiment, module 180 is intermittently provided with power, from a time period before an X-ray is emitted from X-ray source 138, to a time period after the signal from SDD 82 is processed by module 180. Providing module 180 with power at the desired times may be achieved in a variety of ways. In one embodiment, statistics based on mean count rates and signal history can provide a prediction of when power should be provided to module 180. In another embodiment, a delay line, such as a low-power analog delay line (e.g., CCD, acoustic surface waves, ultrasonic delay line, delay cable, LC delay line), is included in XRF spectrometer 80. A signal inspector is connected to the input, or near the input, of the delay line. The signal inspector, along with the output of the delay line, is also connected to module 180. Upon detecting a signal at the input of the delay line, the signal inspector switches on power to module 180. When the signal reaches the output of the delay line, controller 126 is prepared to receive it.

Combining of power control functions and signal control functions in a single module may not allow for complete separation between the frequency ranges of the supply circuits and the frequency ranges of the signal processing circuits. Shifting the switching frequency of the power circuits above the passband of the signal processing circuits, in situations where that shift is possible, may reduce efficiency due to inherently lossy components (e.g., switching loss). Additionally, because the power spectrum of switched mode power supplies spreads over all harmonics of the fundamental frequency, simply shifting power supply switching frequency below the passband of the signal processing circuits is also not efficient.

In certain signal processing schemes, zeroes of the transfer functions exist even near the passband. For example, the transfer function of a gated integrator with respect to noise suppressing is more or less described by the term sin(x)/x which exhibits unlimited number of zeros at x=n* Pi (n=1 . . . ). Signal processing and power control module 180 is configured such that the operating frequencies of possible noise sources are adjusted in a way that potentially interfering signal frequencies match the zeros in the transfer function. Such a configuration results in noise reduction.

In another embodiment of module 180, potential noise sources are operated synchronously, preferably at the same clock or at multiples of a common master clock. Synchronous operation of potential noise sources may occur with, or instead of, matching of signal frequencies, as is described above. In a further embodiment, adaptive phase shifting is utilized in module 180 which results in different noise sources canceling one another out.

As stated above, noise reduction circuitry typically requires power, and is therefore a drain on a system powered by a battery. A variety of approaches may be utilized to improve noise immunity of the electronic circuitry of XRF spectrometer 80. In an exemplary embodiment, to improve noise immunity, which in turn may reduce the power consumption of noise reduction circuitry, 3D simulation may be used to design routing traces along equi-potentials and/or position compensating lines. In another exemplary embodiment, noise susceptive components are replaced by more immune components. In yet another exemplary embodiment, active noise cancelling is implemented by positioning noise sensing loops near critical signal traces. Any other known methods of improving noise immunity may be used to reduce the noise within the electrical circuits of XRF spectrometer 80.

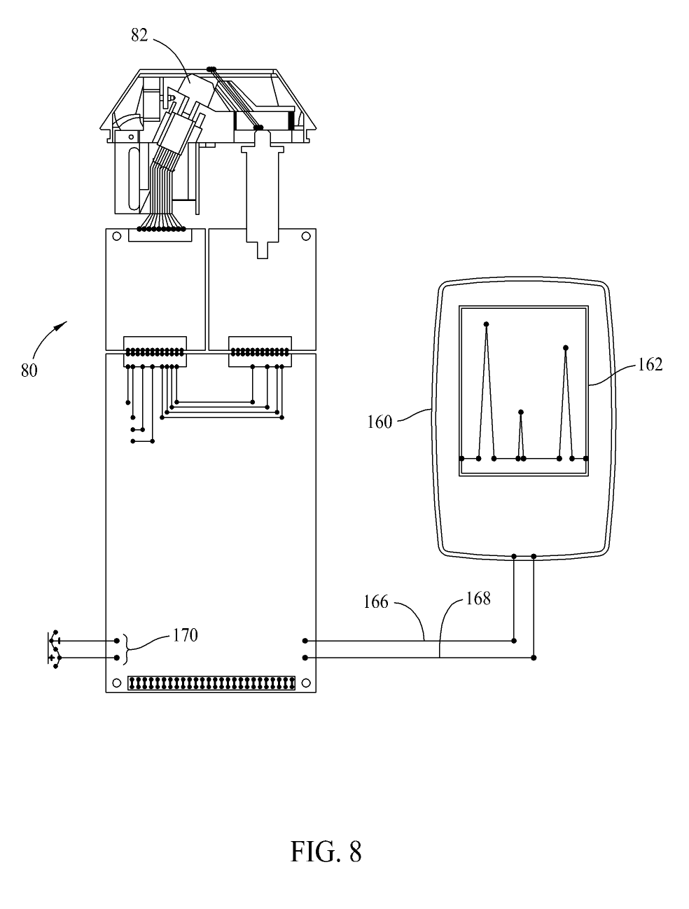

FIG. 8 is a schematic diagram of handheld XRF spectrometer 80 in communication with a computing device 160. In example embodiments, computing device 160 may include one or more of a microprocessor, processor, microcontroller, microcomputer, programmable logic controller, application specific integrated circuit, and other programmable circuits. In another alternative embodiment, computing device 160 may include one or more of a personal computer, a server, a personal digital assistant, and any other device capable of receiving and processing data from handheld XRF spectrometer 80. In the illustrated embodiment, computing device 160 includes an output display 162. Output display 162 may be a printer, a screen, or any other device that allows a user to view an output from computing device 160. Computing device 160 may also include an input device (not shown in FIG. 8). The input device may include one or more of a keypad, touch screen, jog dial, microphone, and any other input device capable of providing instructions from a user to at least one of computing device 160 and handheld XRF spectrometer 80.

In the illustrated embodiment, cables 166 and 168 provide a path for at least one of data communications between handheld XRF spectrometer 80 and computing device 160 and electrical power between handheld XRF spectrometer 80 and computing device 160. However, this link is not limited to only a cable or a wire. In another exemplary embodiment, handheld XRF spectrometer 80 and computing device 160 include wireless capabilities, for example, Bluetooth® wireless capabilities. Bluetooth® is a registered trademark of Bluetooth SIG of Bellevue, Wash.

FIG. 8 also illustrates a power input 170 positioned on handheld XRF spectrometer 80. In one exemplary embodiment, power input 170 is a port configured to receive a plug that connects power input 170 to a power source, for example, a standard electrical outlet or other power supply. In another exemplary embodiment, power input 170 is a pair of battery terminals. In yet another exemplary embodiment, power input 170 provides a connection between a battery within handheld XRF spectrometer 80 and a battery charger. In this embodiment, the battery charger is connected to an external power supply and configured to charge the battery of XRF spectrometer 80 when connected. The handheld XRF spectrometer 80 is encased within a housing, as described above. In this exemplary embodiment, the housing includes a battery holder (not shown in FIG. 5) configured to secure at least one battery within the housing. The battery holder is also configured to align the terminals of the batteries with the corresponding power input 170 of handheld XRF spectrometer 80. In exemplary embodiments, it is desirable for the at least one battery to have a high energy storage capacity such as a for example, Lithium ion battery, a Lithium polymer battery, or a fuel cell.

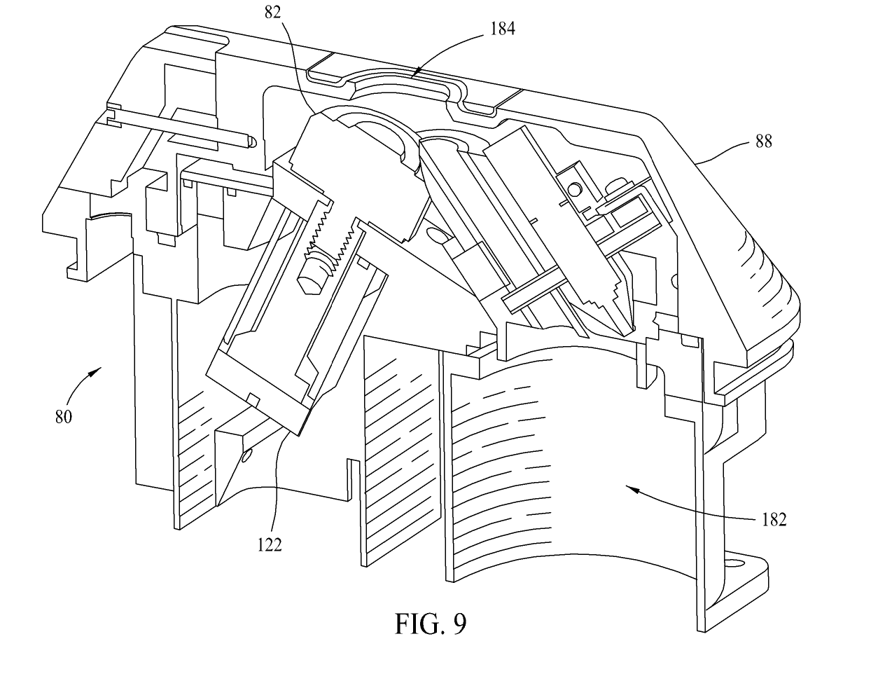

FIG. 9 is a cross-sectional perspective view of nosepiece 88 of handheld XRF spectrometer 80 incorporating SDD 82 of FIGS. 4-7. Components that are common to FIGS. 4-7 are illustrated with the same reference numerals. In an exemplary embodiment, radiation source 138 (shown in FIG. 4) is positioned at a location 182, and thin window 112 (shown in FIG. 4) is positioned at an opening 184 within nosepiece 88.

While the invention has been described in terms of various specific embodiments, those skilled in the art will recognize that the invention can be practiced with modification within the spirit and scope of the claims.

What is claimed is:

1. A handheld X-ray fluorescence (XRF) spectrometer comprising:
a radiation source;
a silicon drift detector (SDD);
a cooling device configured to regulate the temperature of said SDD;
at least one signal processing and power control module coupled to at least one of said radiation source, said SDD, and said cooling device, said at least one signal processing and power control module including at least one input/output connector; and
a housing substantially encasing said radiation source, said SDD, said cooling device, and said at least one signal processing and power control module.

2. A handheld XRF spectrometer in accordance with claim 1, wherein said radiation source comprises at least one of an electron beam source, a radioisotope source, a pyroelectric source, and an X-ray tube.

3. A handheld XRF spectrometer in accordance with claim 1, wherein said SDD is configured to:
detect secondary radiation emitted by a sample being tested due to exposure to radiation from said radiation source;
convert the detected secondary radiation into an electrical signal; and
provide the electrical signal to said at least one signal processing and power control module.

4. A handheld XRF spectrometer in accordance with claim 3 further comprising a computing device coupled to said at least one input/output connector, said computing device configured to receive the electrical signal from said at least one signal processing and power control module.

5. A handheld XRF spectrometer in accordance with claim 4, wherein said computing device is configured to analyze the electrical signal received from said at least one signal processing and power control module.

6. A handheld XRF spectrometer in accordance with claim 4, wherein said computing device is positioned at least one of internal to said housing and external to said housing.

7. A handheld XRF spectrometer in accordance with claim 1, wherein said at least one signal processing and power control module is configured to receive power from a power source and distribute the power to components of said XRF spectrometer.

8. A handheld XRF spectrometer in accordance with claim 7, wherein said power source is a battery.

9. A handheld XRF spectrometer in accordance with claim 1, wherein said housing comprises a nose portion and a handle portion.

10. A handheld XRF spectrometer in accordance with claim 9, wherein said handle portion is configured to facilitate handheld operation of said XRF spectrometer.

11. A handheld XRF spectrometer in accordance with claim 9, wherein said nose portion comprises a protective enclosure that facilitates release of radiation and detection of secondary radiation, while shielding said SDD from at least one of electronic interference and ambient light.

12. A handheld XRF spectrometer in accordance with claim 11, wherein said protective enclosure at least partially comprises Beryllium.

13. A signal processing and power control module for use with an X-ray fluorescence (XRF) spectrometer that includes a silicon drift detector (SDD), said module comprising:
at least one system controller configured to provide power and control instructions to at least one of a radiation source and a cooling device; and
at least one signal processor configured to receive operating information from at least one of the radiation source and the cooling device, said at least one signal processor further configured to provide the operating information to a computing device.

14. A signal processing and power control module in accordance with claim 13, wherein said at least one signal processor is further configured to receive an electrical signal, which corresponds to a detected secondary radiation, from the SDD.

15. A signal processing and power control module in accordance with claim 14, wherein said at least one signal processor transmits the electrical signal to said computing device for at least one of analysis and display.

16. A signal processing and power control module in accordance with claim 13, wherein the radiation source is configured to provide said at least one signal processor with radiation source operating information and also selectively emit radiation.

17. A signal processing and power control module in accordance with claim 13, wherein said at least one system controller is further configured to provide power to components of the XRF spectrometer including at least one of an analog-to-digital converter and a field programmable gate array.

18. A signal processing and power control module in accordance with claim 17, wherein said components of the XRF spectrometer are selected to operate within a predetermined voltage range.

19. A signal processing and power control module in accordance with claim 13, wherein said at least one system controller and said at least one signal processor are configured such that operating frequencies of noise sources are adjusted to match interfering signal frequencies to zeros of a transfer function.

20. A signal processing and power control module in accordance with claim 13, wherein said at least one system controller and said at least one signal processor are configured such that noise sources are operated synchronously.

21. A method of controlling operation of a handheld X-ray fluorescence (XRF) spectrometer that includes a silicon drift detector (SDD), said method comprising:
configuring a signal processing and power control module to distribute electrical power from a power source to a plurality of components of the XRF spectrometer, the components of the XRF spectrometer selected to operate within a predetermined voltage range; and
configuring the signal processing and power control module to control operation of at least one of a radiation source and a cooling device.

22. A method in accordance with claim 21, wherein configuring the signal processing and power control module to distribute electrical power further comprises configuring the signal processing and power control module to provide at least one supply voltage to components of the XRF spectrometer.

23. A method in accordance with claim 21, wherein configuring the signal processing and power control module to distribute electrical power from a power source further comprises configuring the signal processing and power control module to provide at least one bias voltage to the SDD.

24. A method in accordance with claim 21, wherein configuring the signal processing and power control module to distribute electrical power from a power source further comprises configuring the module to selectively provide voltages to predetermined components of the XRF spectrometer at specific times in order to limit power usage.

25. A method in accordance with claim 21, wherein configuring the signal processing and power control module to distribute electrical power from a power source further comprises configuring the signal processing and power control module to selectively provide a first plurality of voltages and a second plurality of voltages to the plurality of components of the XRF spectrometer, the first plurality of voltages being lower than the second plurality of voltages.

26. A method in accordance with claim 21 further comprising configuring the signal processing and power control module to transmit signals produced by the SDD to a computing device for at least one of analysis and display.

27. A method in accordance with claim 21 further comprising adjusting operating frequencies of noise sources such that interfering signal frequencies match zeros in a transfer function.
